(19) United States
(12) Patent Application Publication
(10) Pub. No.: US 2016/0227352 A1
(43) Pub. Date: Aug. 4, 2016

(54) AUXILIARY BLUETOOTH DEVICE

(71) Applicant: Babak Khalilzadeh, Los Angeles, CA (US)

(72) Inventor: Babak Khalilzadeh, Los Angeles, CA (US)

(21) Appl. No.: 14/803,717

(22) Filed: Jul. 20, 2015

Related U.S. Application Data
(63) Continuation of application No. 14/624,449, filed on Feb. 17, 2015.
(60) Provisional application No. 62/111,562, filed on Feb. 3, 2015.

(51) Int. Cl. H04W 4/00; H04W 76/02; H04W 8/00

(52) U.S. Cl. CPC H04W 4/008; H04W 8/005; H04W 76/023

(57) ABSTRACT

An auxiliary wireless device having a transceiver, battery pack and an audio connector is disclosed herein. The device may also have a button for making the device findable by a second wireless enabled device. The auxiliary wireless device may be connected to a normally non-wireless enabled device so that audio signals may be transmitted between the normally non-wireless enabled device and the second wireless enabled device.

### CROSS-REFERENCE TO RELATED APPLICATIONS

The present application is a continuation patent application of U.S. patent application Ser. No. 14/624,449, filed on Feb. 17, 2015 which claims the benefit of U.S. Provisional Patent Application No. 62/111,562, filed on Feb. 3, 2015, the entire contents of which are incorporated herein by reference.

### STATEMENT RE: FEDERALLY SPONSORED RESEARCH/DEVELOPMENT

Not Applicable

### BACKGROUND

The various embodiments and aspects described herein relate to a wireless enabling device for a non-wireless device.

Antiquated electronics were manufactured without any wireless communication capabilities. As such, antiquated electronics require a wired connection between the antiquated electronics and a wireless enabled device. The wireless enabled device accommodates antiquated electronics by providing an audio jack so that the wired connection may be established between the audio jack of the wireless enabled device and the audio jack of the antiquated electronics. Unfortunately, the wired connection has certain downfalls such as aesthetics and maneuverability.

Accordingly, there is a need in the art for an improved communication link between electronic devices.

### BRIEF SUMMARY

The various aspects and embodiments described herein address the needs discussed above, discussed below and those that are known in the art.

An auxiliary wireless device that enables a normally non-wireless enabled device to wirelessly communicate with a wireless enabled device is disclosed herein. The auxiliary wireless device includes a transceiver, battery pack and an audio connector. The audio connector is insertable into an audio jack of the normally non-wireless enabled device. A button on the auxiliary wireless device may be depressed in order to make the auxiliary wireless device findable by a wireless enabled device for establishing a communication link between the auxiliary wireless device and the wireless enabled device. In this manner, an audio signal may be communicated between the normally non-wireless enabled device and the wireless enabled device.

More particularly, an auxiliary wireless device for enabling wireless connection between a first non-wireless enabled device to a second wireless enabled device is disclosed. The auxiliary wireless device may comprise a wireless transceiver, a rechargeable battery, an audio connector and a button. The wireless transceiver may transmit electronic data through the auxiliary wireless device between the first non-wireless enabled device and the second wireless enabled device. The rechargeable battery may be in electrical communication with the wireless transceiver for providing power to the wireless transceiver. The audio connector may be in electrical communication with the wireless transceiver. The audio connector may be sized and configured to be inserted into an audio jack of the first non-wireless enabled device. The button may be in communication with the wireless transceiver and operative to make the auxiliary wireless device findable by the second wireless enabled device.

The wireless transceiver may operate on a Bluetooth standard or a Wi-Fi standard.

The auxiliary wireless device may have a light source for indicating a charge level of the rechargeable battery.

The audio connector may be a RCA connector, 2.5 mm phone connector, 3.5 mm phone connector, 6.5 mm phone connector or other connector known in the art or developed in the future.

In another aspect, a method for utilizing an auxiliary wireless device for establishing a wireless communication link between a first non-wireless enabled device and a second wireless enabled device is disclosed. The method may comprise the steps of inserting an audio connector of the auxiliary wireless device into an audio jack of the first non-wireless enabled device; depressing a button on the auxiliary wireless device so that the auxiliary wireless device is findable by a second wireless enabled device; configuring the second wireless enabled device to a search mode for finding the auxiliary wireless device; and establishing a connection between the auxiliary wireless device and the second wireless enabled device for providing a communication link between the first non-wireless enabled device and the second wireless enabled device.

In the method, the first non-wireless enabled device may be a stereo of an automobile, a stereo amplifier, home stereo or a head phone.

In another aspect, an auxiliary wireless device for enabling wireless connection between a first non-wireless enabled device to a second wireless enabled device is disclosed. The auxiliary wireless device may comprise a wireless transceiver, a rechargeable battery, a universal serial bus (USB) connector and a button. The wireless transceiver may transmit electronic data (e.g., music file, audio file or data file) through the auxiliary wireless device between the first non-wireless enabled device and the second wireless enabled device. The rechargeable battery may be in electrical communication with the wireless transceiver for providing power to the wireless transceiver. The USB connector may be in electrical communication with the wireless transceiver. The USB connector may be sized and configured to be inserted into a USB port of the first non-wireless enabled device. The button may be in communication with the wireless transceiver and operative to make the auxiliary wireless device findable by the second wireless enabled device.

The wireless transceiver may operate on a Bluetooth standard. Alternatively, or additionally, the wireless transceiver may operates on a Wi-Fi standard.

The auxiliary wireless device may further comprise a light source for indicating a charge of the rechargeable battery.

The USB connector may be a USB or a mini USB.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 illustrates a kit of an auxiliary wireless device;

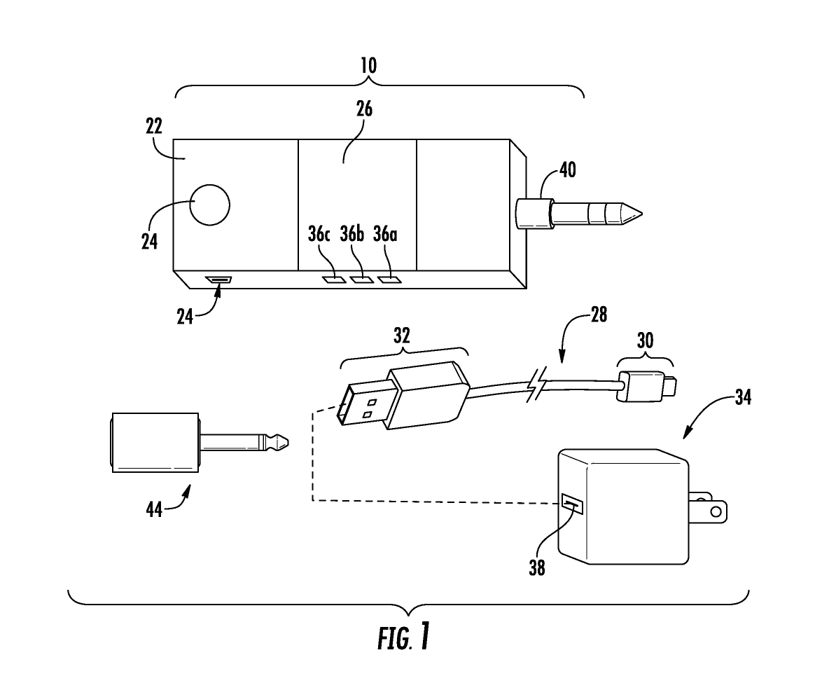

FIG. 2 illustrates the auxiliary wireless device shown in FIG. 1 enabling a non-wireless enabled device (i.e., automobile stereo) to wirelessly communicate with a wireless smart phone;

FIG. 3 illustrates the auxiliary wireless device shown in FIG. 1 enabling a non-wireless enabled device (i.e., home stereo) to wirelessly communicate with the smart phone;

FIG. 4 illustrates the auxiliary wireless device shown in FIG. 1 enabling a non-wireless enabled device (i.e., guitar effects pedal board) to wirelessly communicate with a wireless headphone or a second non-wireless enabled device (i.e., guitar); and

FIG. 5 illustrates another kit of the auxiliary wireless device.

### DETAILED DESCRIPTION

Referring now to the drawings, an auxiliary wireless device 10 for wirelessly connecting a first non-wireless enabled device 12, 14, 16 such as a stereo of an automobile 12, home stereo amplifier 14 and a guitar effects pedal 16 with a second wireless enabled device 18, 20 such as a smartphone 18 and/or a headphone 20 is disclosed. The auxiliary wireless device 10 provides a physical connection to an audio jack 42 of the first non-wireless enabled device 12, 14, 16 and has a transceiver for wirelessly communicating with the second wireless enabled device 18, 20.

The auxiliary wireless device 10 is shown as having a box form factor. However, other form factors are also contemplated. By way of example and not limitation, the form factor of the auxiliary wireless device 10 may be round, oval or other configurations. The housing of the auxiliary wireless device 10 may have a button 24 that is accessible from the outside. The button 24 when depressed broadcasts a signal through the transceiver 22 so that the auxiliary wireless device 10 is findable by the second wireless enabled device. The auxiliary wireless device 10 is described as having the transceiver 22. However, it is also contemplated that the device 10 may be fitted with a receiver for receiving signals from the second wireless enabled device 18, 20. In order to establish the communication between the auxiliary wireless device 10 and the second wireless enabled device 18, 20, the initial communication may be established with a hardwired connection between a USB port 24 and the second wireless enabled device 18, 20.

The auxiliary wireless device 10 may be powered by a rechargeable battery 26. The rechargeable battery 26 may be recharged by way of the USB port 24. In particular, the auxiliary wireless device 10 may be provided with a cable 28 that has USB connectors 30, 32 on both ends of the cable 28. The USB connector 30 is insertable into the USB port 24 of the auxiliary wireless device 10. The USB connector 32 is operative to fit into an outlet plug 34 so that electricity can flow through the cable 28 into the battery 26 for recharging. Alternatively, the USB connector 32 can be connected to a USB port 24 of the second wireless enabled device 18, 20 in order to establish the communication link between the second wireless enabled device 18, 20 and the auxiliary wireless device 10. In this regard, when the USB connectors 30, 32 are connected to the USB port 24 of the auxiliary wireless device 10 and the second wireless enabled device 18, 20, the user depresses button 23 that starts a script to establish a wireless communication between the second wireless enabled device 18, 20 and the transmitter 22 of the auxiliary wireless device 10.

The housing of the auxiliary wireless device 10 may also have three light sources 36a, b and c. The light source 36a emits a red color. The light source 36b emits a yellow color. The light source 36c emits a green color. When the battery 26 is fully charged, light source 36c emits a green light to indicate that the battery 26 is fully charged. This would make it an incomplete sentence. Light sources 36b, 36a do not emit any light. If the battery 26 is not fully charged and holds about one half of a charge, the light source 36b emits a yellow light. Light sources 36c and 36a do not emit any light. When the battery 26 has a low charge, light source 36a emits a red light to indicate such battery condition. Light sources 36b, 36b do not emit any light.

As discussed above, the outlet plug 34 is operative to be plugged into an electrical socket for providing electricity through the cable 28. The outlet plug 34 has two prongs that can be inserted into the electrical outlet. The outlet plug 34 also has a USB connector 38 that can receive the USB connector 32 of the cable 28.

The auxiliary wireless device 10 also has an audio connector 40. The audio connector 40 is in electrical communication with the transceiver 22 and feeds an audio signal to an audio jack 42 of the first non-wireless enabled device 12, 14, 16. Conversely, it is also contemplated that the first non-wireless enabled device 16 can transmit an audio signal through the transceiver 22 of the auxiliary wireless device 10 to the wireless headphone 20.

The audio connector 40 is shown as being rigidly fixed to the housing of the auxiliary wireless device 10. However, it is also contemplated that the audio connector 40 may be connected to the housing of the auxiliary wireless device 10 by way of a flexible electrical cable (not shown). This allows the person to place the housing of the auxiliary wireless device 10 on a support surface away from the audio jack 42 of the first non-wireless enabled device 16. When the audio connector 40 is fixedly attached to the housing of the auxiliary wireless device 10, the housing of the auxiliary wireless device 10 protrudes outward in line with the audio jack 42 of the first non-wireless enabled device 12, 14, which may not be an optimal position.

The audio connector 40 is shown as being a 6.5 mm phone connector. However, the audio connector 40 may be configured as a 2.5 mm phone connector or a 3.5 mm phone connector. Other audio connectors 40 are also contemplated including but not limited to optical audio connectors, and other unique audio connectors known in the art or developed in the future.

The auxiliary wireless device 10 may also be provided with an audio connector converter 44. The converter 44 converts the audio connector 40 built into the auxiliary wireless device 10 from one type or size of audio connector 40 to another type or size of audio connector 40. By way of example and not limitation, the audio connector 40 may be a 2.5 mm phone connector 40. The converter 44 may provide a 3.5 mm phone connector 40. The converter 44 in this instance will have a receiving hole that receives the 2.5 mm audio connector 40 so that the auxiliary wireless device 10 may mate with an audio jack 42 designed for a 3.5 mm phone connector 40.

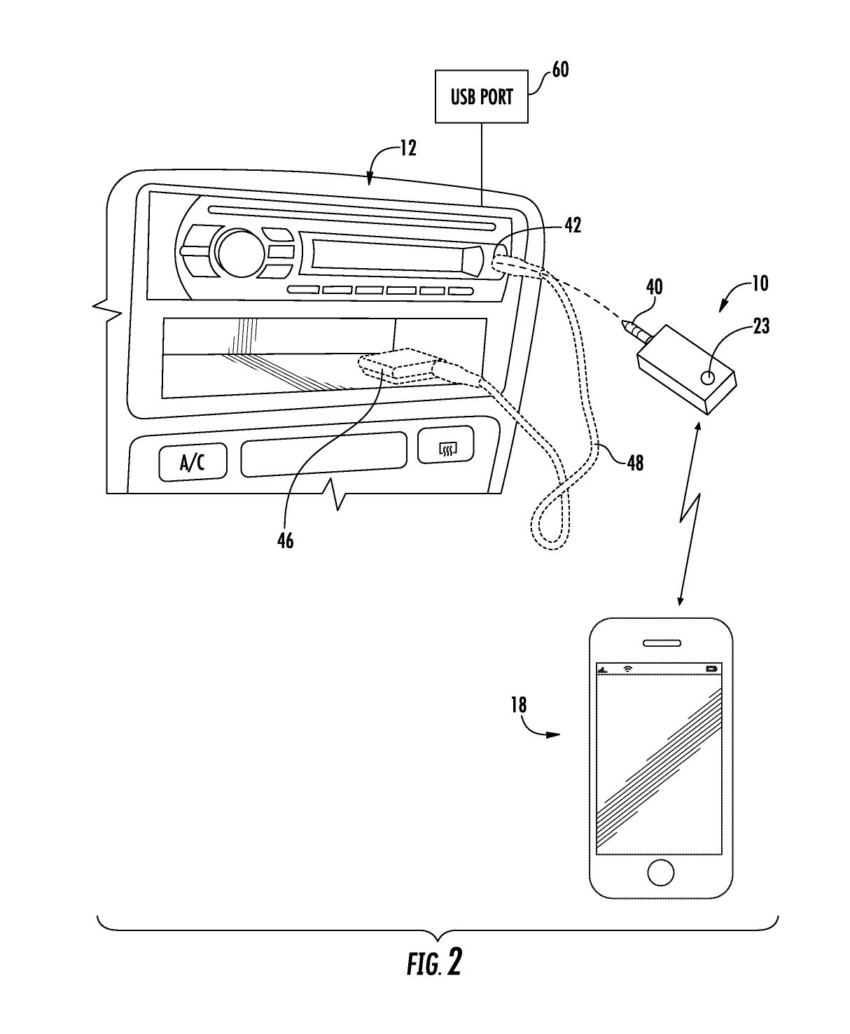

Referring now to FIG. 2, a stereo 12 for an automobile may not be equipped to wirelessly communicate with a wireless enabled device 18. As such, the stereo 12 communicates with an electronic device 46 through a wired connection 48. Unfortunately, the wired connection 48 is aesthetically messy and inconvenient to hook up each time the driver enters or leaves the automobile. In lieu of a wired connection 48, the auxiliary wireless device 10 may be physically connected to the stereo 12 of the automobile. In particular, the audio connector 40 of the auxiliary wireless device 10 may be inserted into an audio jack 42 of the stereo 12 of the automobile. Thereafter, the smartphone 18 is placed in search mode for finding a discoverable wireless signal. The user then depresses the button 23 to make the auxiliary wireless device 10 findable. The transceiver 22 emits a signal that can be sensed by the smart phone 18. The smartphone 18 indicates that the auxiliary wireless device 10 has been found and requests the user's permission to establish a wireless connection between the auxiliary wireless device 10 and the smartphone 18. Thereafter, each time the smartphone 18 is within a wireless range of the auxiliary wireless device 10, a communication link is established between the auxiliary wireless device 10 and the smartphone 18. The user may play an audio recording from the smartphone 18 which is wirelessly transmitted to the auxiliary wireless device 10 and fed into the sound system of the stereo 12 of the automobile to play the audio recording from the speakers of the automobile. Moreover, an audio signal that emits a sound that would have been broadcast over a speaker of the smartphone 18 may now be wirelessly communicated to the auxiliary wireless device 10 so that the audio signal and corresponding sound may be played through the speakers of the stereo system 12 of the automobile instead. In this regard, the auxiliary wireless device 10 enables wireless connections between a non-wireless enabled device 12 such as a car stereo and a wireless enabled device such as a tablet computer or smartphone 18 (e.g., iPhone).

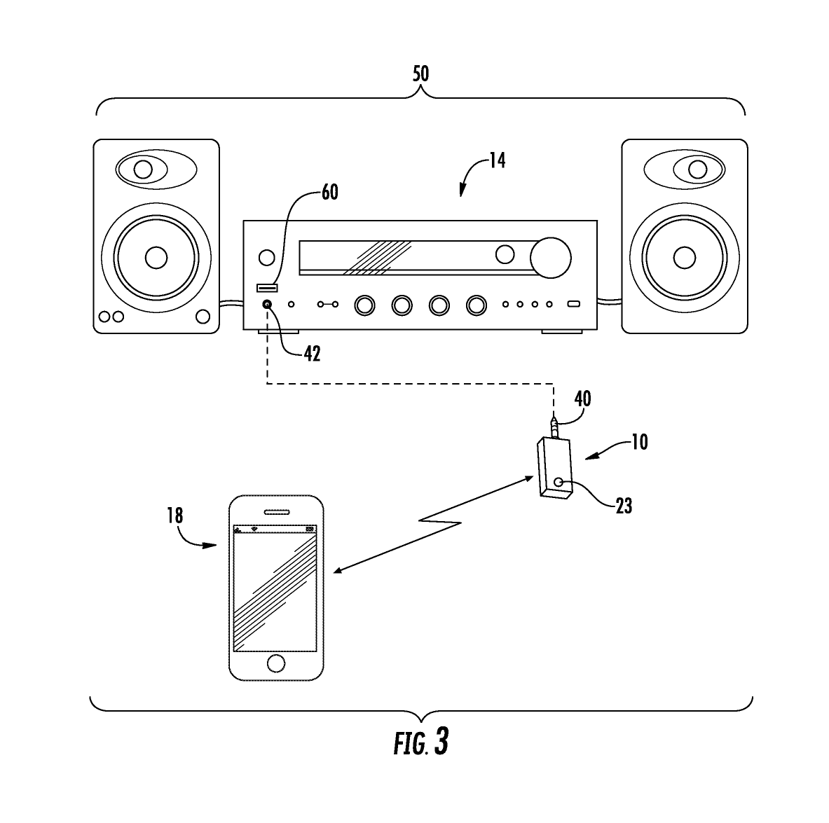

Referring now to FIG. 3, a home stereo 14 may not be equipped to wirelessly communicate with a wireless enabled device 18. As such, for a home stereo 14 to play music or other audio stored on the wireless enabled device 18, a wired connection is required between the smartphone 18 and the home stereo 14. Unfortunately, the wired connection is aesthetically messy and inconvenient since the owner of the phone 18 may need to utilize the phone 18 and cannot stand near the home stereo 14 indefinitely.

In lieu of a wired connection, the auxiliary wireless device 10 may be placed in communication with the home stereo 14. In particular, the audio connector 40 of the auxiliary wireless device 10 may be inserted into an audio jack 42 of the home stereo 14. Thereafter, the smartphone 18 is placed in search mode for finding a discoverable wireless signal. The user then depresses the button 23 to make the auxiliary wireless device 10 findable. The transceiver 22 emits a signal that can be sensed by the smartphone 18. The various aspects and embodiments described herein have been generically described in relation to a wireless communication link between two devices. However, the auxiliary wireless device 10 may be manufactured under different wireless standards. By way of example and not limitation, the auxiliary wireless device 10 may be a Bluetooth capable device in that the device 10 meets Bluetooth Special Interests Group standards. It is also contemplated that the auxiliary wireless device 10 may be a Wi-Fi capable device. Other short range wireless communication technology may be implemented into the device 10 known in the art or developed in the future. The smartphone 18 indicates that the auxiliary wireless device 10 has been found and requests the user's permission to establish a wireless connection between the auxiliary wireless device 10 and the smartphone 18. Thereafter, each time the smartphone 18 is within a wireless range of the auxiliary wireless device, a communication link is established between the auxiliary wireless device 10 and the smartphone 18. Alternatively, the auxiliary wireless device 10 may be programmed to establish a wireless connection with the smartphone 18 only after the button 23 is depressed. Once the smartphone 18 is out of the wireless range of the auxiliary wireless device 10, the user needs to depress the button 23 again once the smartphone 18 is within the wireless range of the auxiliary wireless device 10. When a communication link is established between the auxiliary wireless device 10 and the smartphone 18, the user may play audio recordings from the smartphone 18 through the auxiliary wireless device 10 and onto the sound system of the home stereo 14. In this regard, the auxiliary wireless device 10 enables wireless communication between a previously non-wireless enabled device such as a home stereo 14 and a wireless enabled device such as a smartphone 18 (e.g., iPhone).

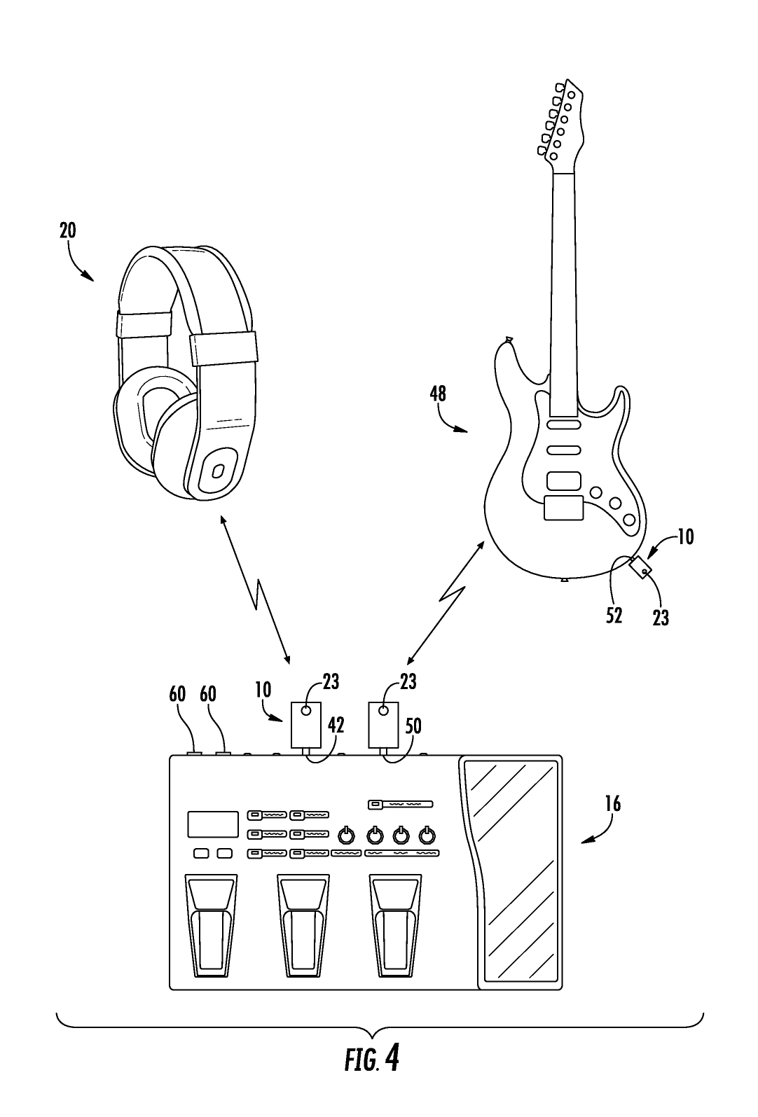

Referring now to FIG. 4, a guitar effects board 16 is shown. The board 16 is not wireless enabled in that the board 16 cannot communicate with a wireless enabled device 18, 20. In order to enable the board 16 for wireless communication, the user may connect the auxiliary wireless device 10 to the board 16. In particular, the user may insert the audio connector 40 of the auxiliary wireless device 10 into an audio jack 42 of the board 16. Upon doing so, the user now needs to link the auxiliary wireless device 10 with the wireless enabled device 20, for example, a headphone 20. To do so, the user depresses the button 23 on the auxiliary wireless device 10 to make the auxiliary wireless device 10 findable. After depressing the button 23, the user depresses a button on the headphone 20 in order to search for the auxiliary wireless device 10. Once found, the auxiliary wireless device 10 can now wirelessly communicate with the headphone 20. Instead of outputting the guitar output to a speaker, the guitar sound is wirelessly outputted to the headphone 20.

Moreover, the auxiliary wireless device 10 may be operative to make two different non-wireless enabled devices such as the board 16 and a guitar 48 to be in wireless communication with each other. By way of example and not limitation, the board 16 may have a guitar jack 50. The guitar jack 50 normally receives a wire connector of an audio cable to provide a wired audio communication with the guitar 48. In lieu of the physical cabled communication, the audio connector 40 of a first auxiliary wireless device 10 may be inserted into the guitar jack 50 of the board 16. Moreover, a second auxiliary wireless device 10 may be connected to the guitar 48. In particular, the audio connector 40 of the second auxiliary wireless device 10 may be plugged into an output jack 52 of the guitar 48. The buttons 23 of the first and second auxiliary wireless devices 10 may be depressed so that the devices can find each other and to establish a wireless communication therebetween. The auxiliary wireless devices 10 may be programmed to establish wireless communication with the headphone 20 and/or the auxiliary wireless device 10 plugged into the guitar 48 whenever the headphone 20 or the auxiliary wireless device 10 mounted to the guitar 48 are within the wireless ranges of the auxiliary wireless devices 10 connected to the board 16. Alternatively, the auxiliary wireless devices 10 in this setup may be programmed so that wireless communications can only be reestablished after the wireless communication is broken by re-depressing the button 23 on the auxiliary wireless devices 10.

As discussed herein, a plurality of non-wireless enabled devices such as an automobile stereo 12, home stereo 14 or a guitar effects pedal board 16 have been described in relation to the auxiliary wireless device 10. However, other types of non-wireless enabled devices are also contemplated. The examples provided herein are not meant to limit application of the auxiliary wireless device 10 but are merely examples of use of the auxiliary wireless device 10 for enabling a previously non-wireless enabled device 12, 14, 16 to be in enabled wireless communication with another wireless enabled device 18, 20. Moreover, the wireless enabled devices were discussed in relation to the smartphone 18 and headphone 20. However, other wireless enabled devices are also contemplated. By way of example and not limitation, other wireless enabled devices may include a wireless tablet computer, etc. The examples provided herein for the wireless enabled device are merely examples and are not meant to limit the application of the auxiliary wireless device 10.

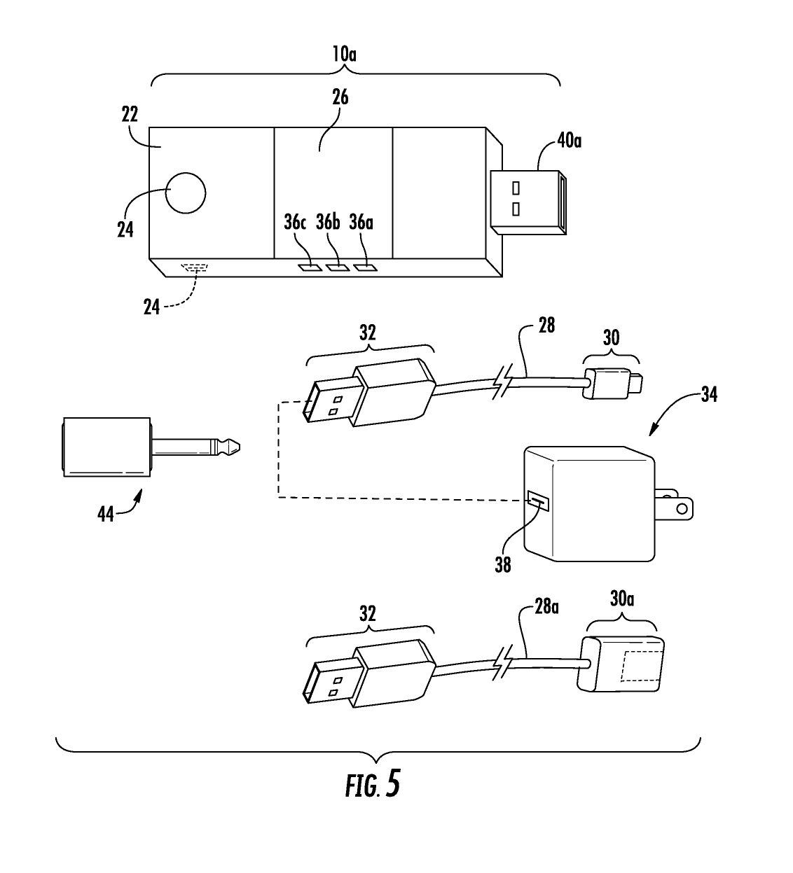

Referring now to FIG. 5, a second embodiment of the auxiliary wireless device 10a is shown. In this embodiment, the audio connector 40 has been replaced with a USB connector 40a. In this manner, the auxiliary wireless device 10a can be connected to a computer USB port 60 or USB port 60 of an electronic device. The auxiliary wireless device 10a may provide wireless communication with another wireless enabled device. By way of example and not limitation, a computer may be wirelessly enabled but not Bluetooth enabled. The auxiliary wireless device 10a may provide the electronic device with Bluetooth capabilities. Conversely, if the computer is enabled to communicate wirelessly through a different standard other than Wi-Fi (e.g., Bluetooth standard), the auxiliary wireless device 10a may enable communication over a Wi-Fi network. In this regard, the auxiliary wireless device 10a provides Wi-Fi and/or Bluetooth capabilities to a non-Wi-Fi and/or non Bluetooth enabled device.

The USB port 24 is optional for the auxiliary wireless device 10a. If the USB port 24 is provided, cable 28 functions in the same manner as described above in relation to the auxiliary wireless device 10. However, if the USB port 24 is not incorporated into the auxiliary wireless device 10a, then cable 28a is provided in which the connector 30a is operative to provide a physical connection with the USB connector 40a. The battery pack 26 is recharged with the cable 28a through a physical connection between the USB connector 40a and the USB port 30a. Moreover, the communication link may be established with a headphone through cable 28a in connection with the USB connector 40a.

The auxiliary wireless device 10a may be implemented in the following manner. If the automobile stereo 12a has a USB port 60 (see FIG. 2), the USB connector 40a of the auxiliary wireless device 10a may be physically connected into the USB port 60 of the automobile stereo 12. The auxiliary wireless device 10a provides wireless capabilities to the automobile stereo 12 based on the standard to which the auxiliary wireless device 10a is built. The auxiliary wireless device 10a may provide Wi-Fi and/or Bluetooth capabilities to the automobile stereo 12. The auxiliary wireless device 10a functions in the same manner as discussed above in relation to auxiliary wireless device 10 except that the audio connector 40 is replaced with the USB connector 40a. Moreover, power can be supplied to the auxiliary wireless device 10a through the physical connection between the USB port 60 of the automobile stereo 12 and the audio connector 40a of the auxiliary wireless device 10a to power the transceiver of the auxiliary wireless device 10a and also to recharge the battery 26 of the auxiliary wireless device 10a. Similarly, the auxiliary wireless device 10a may be connected to a USB port 60 (see FIG. 3) of a home stereo 14 to provide wireless capabilities (e.g., Bluetooth and/or Wi-Fi capabilities) to the home stereo 14.

Furthermore, the auxiliary wireless device 10a may be plugged into a guitar effects pedal board 16 provided that the pedal board 16 has USB ports 60 for communication with the headphone 20 and/or the guitar 48.

The auxiliary wireless device 10, 10a described herein may have a circuit board, embedded software and circuits operative to operate the auxiliary wireless device 10, 10a as described above.

The above description is given by way of example, and not limitation. Given the above disclosure, one skilled in the art could devise variations that are within the scope and spirit of the invention disclosed herein, including various ways of configuring the form factor of the auxiliary wireless device 10. Further, the various features of the embodiments disclosed herein can be used alone, or in varying combinations with each other and are not intended to be limited to the specific combination described herein. Thus, the scope of the claims is not to be limited by the illustrated embodiments.

1. An auxiliary wireless device for enabling wireless connection between a first non-wireless enabled device to a second wireless enabled device, the auxiliary wireless device comprising:
a wireless transceiver for transmitting electronic data through the auxiliary wireless device between the first non-wireless enabled device and the second wireless enabled device;
a rechargeable battery in electrical communication with the wireless transceiver for providing power to the wireless transceiver;
an audio connector in electrical communication with the wireless transceiver, the audio connector sized and configured to be inserted into an audio jack of the first non-wireless enabled device;
a button in communication with the wireless transceiver and operative to make the auxiliary wireless device findable by the second wireless enabled device.

2. The auxiliary wireless device of claim 1 wherein the wireless transceiver operates on a Bluetooth standard.

3. The auxiliary wireless device of claim 1 wherein the wireless transceiver operates on a Wi-Fi standard.

4. The auxiliary wireless device of claim 1 further comprising a light source for indicating a charge of the rechargeable battery.

5. The auxiliary wireless device of claim 1 wherein the audio connector is a RCA connector, 2.5 mm phone connector, 3.5 mm phone connector or 6.5 mm phone connector.

6. A method for utilizing an auxiliary wireless device for establishing a wireless communication link between a first non-wireless enabled device and a second wireless enabled device, the method comprising the steps of:
inserting an audio connector of the auxiliary wireless device into an audio jack of the first non-wireless enabled device;
depressing a button on the auxiliary wireless device so that the auxiliary wireless device is findable by a second wireless enabled device;
configuring the second wireless enabled device to a search mode for finding the auxiliary wireless device;
establishing a connection between the auxiliary wireless device and the second wireless enabled device for providing a communication link between the first non-wireless enabled device and the second wireless enabled device.

7. The method of claim 6 wherein the first non-wireless enabled device is a stereo of an automobile.

8. The method of claim 6 wherein the first non-wireless enabled device is a stereo amplifier.

9. The method of claim 6 wherein the first non-wireless enabled device is a head phone.

10. An auxiliary wireless device for enabling wireless connection between a first non-wireless enabled device to a second wireless enabled device, the auxiliary wireless device comprising:
a wireless transceiver for transmitting electronic data through the auxiliary wireless device between the first non-wireless enabled device and the second wireless enabled device;
a rechargeable battery in electrical communication with the wireless transceiver for providing power to the wireless transceiver;
a universal serial bus (USB) connector in electrical communication with the wireless transceiver, the USB connector sized and configured to be inserted into a USB port of the first non-wireless enabled device;
a button in communication with the wireless transceiver and operative to make the auxiliary wireless device findable by the second wireless enabled device.

11. The auxiliary wireless device of claim 10 wherein the wireless transceiver operates on a Bluetooth standard.

12. The auxiliary wireless device of claim 10 wherein the wireless transceiver operates on a Wi-Fi standard.

13. The auxiliary wireless device of claim 10 further comprising a light source for indicating a charge of the rechargeable battery.

14. The auxiliary wireless device of claim 10 wherein the USB connector is a USB or a mini USB.

15. The auxiliary wireless device of claim 10 wherein the electronic data is a music file, audio file or data file.
